(19) United States
(12) Patent Application Publication
(10) Pub. No.: US 2026/0074189 A1
(43) Pub. Date: Mar. 12, 2026

(54) NEGATIVE ELECTRODE SLURRY, NEGATIVE ELECTRODE, AND ALL-SOLID-STATE BATTERY

(71) Applicant: SAMSUNG SDI CO., LTD., Yongin-si (KR)

(72) Inventors: Young Woo PARK, Yongin-si (KR); Jaejun SONG, Yongin-si (KR); Youngjin CHOI, Yongin-si (KR); Eunhae PARK, Yongin-si (KR); DongIl SHIN, Yongin-si (KR); Ryunmin HEO, Yongin-si (KR); Kyunghee KANG, Yongin-si (KR)

(21) Appl. No.: 19/318,594

(22) Filed: Sep. 4, 2025

(30) Foreign Application Priority Data
Sep. 6, 2024 (KR) 10-2024-0121556

(51) Int. Cl. H01M 4/134; H01M 4/02; H01M 4/62; H01M 4/66; H01M 10/0585; H01M 10/42

(52) U.S. Cl. CPC H01M 4/134; H01M 4/622; H01M 4/628; H01M 4/661; H01M 4/663; H01M 4/667; H01M 4/668; H01M 10/0585; H01M 10/4235; H01M 2004/021; H01M 2004/027

(57) ABSTRACT

A negative electrode slurry, negative electrodes, and all-solid-state batteries are provided. The negative electrode slurry comprises a metal-carbon composite in which a metal and a carbon-based material are chemically bonded by sulfur, a binder, and a solvent. An average particle diameter (D50) of the metal-carbon composite is about 150 nm to about 1,000 nm.

### CROSS-REFERENCE TO RELATED APPLICATION

This application claims priority under 35 U.S.C § 119 to Korean Patent Application No. 10-2024-0121556 filed on Sep. 6, 2024, in the Korean Intellectual Property Office, the disclosure of which is hereby incorporated by reference in its entirety.

### BACKGROUND

The present disclosure relates to a negative electrode slurry, a coating layer formed of the negative electrode slurry, and an all-solid-state battery including the coating layer.

Driven by industrial demands, there is active development of high-energy density and safe batteries. For example, lithium ion batteries are being commercialized in formation-related and communication devices and also in the automotive industry. In the automotive industry, safety is particularly important.

There have been proposed all solid-state batteries in which liquid electrolytes are replaced with solid electrolytes. As all-solid-state batteries do not use flammable organic dispersion mediums, the risk of fire or explosion may be significantly reduced, even in the occurrence of an event such as a short-circuit. Thus, compare to lithium-ion batteries that use electrolyte solutions, all-solid-state batteries may be safter.

### SUMMARY

An embodiment of the present disclosure provides a negative electrode slurry for an all-solid-state battery capable of forming a uniform coating layer on a negative electrode current collector.

An embodiment of the present disclosure provides a coating layer with a uniform thickness.

An embodiment of the present disclosure provides a negative electrode for an all-solid-state battery including the coating layer.

An embodiment of the present disclosure provides an all-solid-state battery including the negative electrode and having excellent efficiency of charging and discharging.

According to an embodiment of the present disclosure, a negative electrode slurry for an all-solid-state battery may comprise a metal-carbon composite in which a metal and a carbon-based material are chemically bonded via sulfur, a binder, and a solvent. An average particle diameter (D50) of the metal-carbon composite may be about 150 nm to about 1,000 nm.

According to an embodiment of the present disclosure, a negative electrode for an all-solid-state battery may comprise a negative electrode current collector and a coating layer. The coating layer may comprise a metal-carbon composite in which a metal and a carbon-based material are chemically bonded via sulfur. An average particle diameter (D50) of the metal-carbon composite may be about 150 nm to about 1,000 nm.

According to an embodiment of the present disclosure, an all-solid-state battery may comprise a positive electrode, the negative electrode discussed above, and a solid electrolyte between the positive electrode and the negative electrode.

### BRIEF DESCRIPTION OF DRAWINGS

FIG. 1 is a cross-sectional view of an all-solid-state battery according to an embodiment of the present disclosure.

FIG. 2 is a cross-sectional view of an all-solid-state battery according to an embodiment of the present disclosure.

FIG. 3 is a perspective view of a negative electrode layer according to an embodiment of the present disclosure.

FIG. 4 is a plan view showing section N of the coating layer depicted in FIG. 3.

FIG. 5 is a plan view showing section N of a coating layer according to a comparative example of the present disclosure.

FIG. 6 are photographs of coating layers according to the present disclosure taken by an optical microscope, where A, B, and C represent coating layers of Embodiment 1, Embodiment 2, and Embodiment 3, respectively.

FIG. 7 is a photograph of a coating layer according to Comparative 3 of the present disclosure taken by an optical microscope.

FIG. 8 is a diagram showing a metal-carbon composite bonded via sulfur according to an embodiment of the present disclosure.

### DETAILED DESCRIPTION OF EMBODIMENTS

In order to describe the configuration and effect of the present disclosure, embodiments of the present disclosure will be described with reference to the accompanying drawings. It should be noted, however, that the present disclosure is not limited to the following exemplary embodiments and may be implemented in various forms. The exemplary embodiments are provided only to disclose the present disclosure and allow those skilled in the art to fully understand the scope of the present disclosure.

In this description, it will be understood that, when an element is referred to as being on another element, the element can be directly on the other element or intervening elements may be present between therebetween. In the drawings, thicknesses of some components are exaggerated for effectively explaining the technical contents. Like reference numerals refer to like elements throughout the specification.

Some embodiments detailed in this description will be discussed with reference to sectional and/or plan views as exemplary views of the present disclosure. In the drawings, thicknesses of layers and regions are exaggerated for effectively explaining the technical contents. Accordingly, regions illustrated in the drawings have general properties, and shapes of regions illustrated in the drawings are used to exemplify specific shapes, but the present disclosure is not limited to the specifically illustrated examples. It will be understood that, although the terms “first”, “second”, “third”, etc. may be used herein to describe various elements, these elements are not limited by these terms. These terms are only used to distinguish one element from another element. The embodiments explained and illustrated herein include complementary embodiments thereof.

The terminology used herein is for the purpose of describing particular embodiments only and is not intended to limit the full scope of the present disclosure. As used herein, the singular forms are intended to include the plural forms as well. The terms ‘comprises/includes’ and/or ‘comprising/including’ used in the specification do not exclude the presence or addition of one or more other components.

In this description, the term “combination thereof” may refer to a mixture, a stack, a composite, a copolymer, an alloy, a blend, or a reaction product.

Unless otherwise especially defined in this description, a particle diameter may be an average particle diameter. In addition, a particle diameter indicates an average particle diameter (D50) where a cumulative volume is about 50 volume % in a particle size distribution. The average particle diameter (D50) may be measured by a method widely known to those skilled in the art, for example, by a particle size analyzer, a transmission electron microscope (TEM) image, or a scanning electron microscope (SEM) image. Alternatively, a dynamic light-scattering measurement device may be used to perform a data analysis, with the number of particles being counted for each particle size range, and then from this, an average particle diameter (D50) value may be calculated. In other cases, a laser scattering method may be utilized to measure the average particle diameter (D50). In the laser scattering method, a target particle is distributed in a dispersion solvent, introduced into a laser scattering particle measurement device (e.g., MT3000 commercially available from Microtrac, Inc), irradiated with ultrasonic waves of 28 kHz at a power of 60 W, and then an average particle diameter (D50) is calculated in the 50% standard of particle diameter distribution in the measurement device.

### All-Solid-State Battery

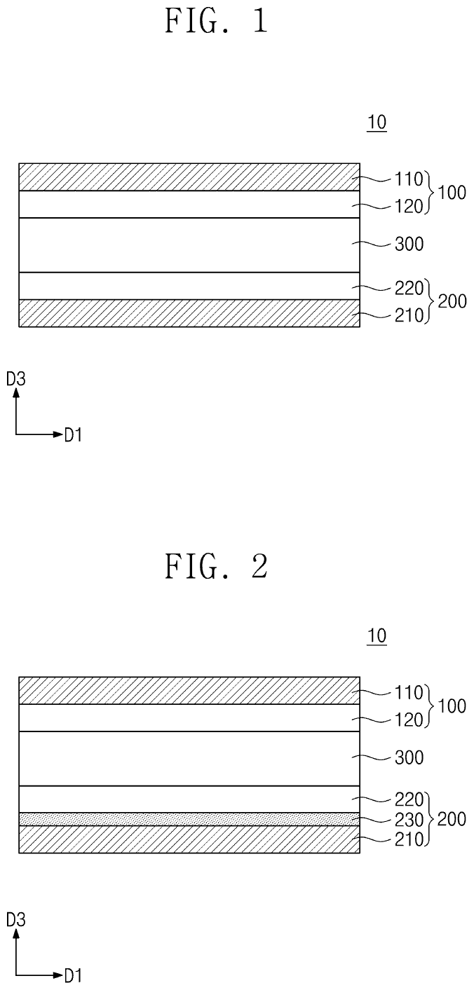

FIGS. 1 and 2 are cross-sectional views of an all-solid-state battery according to an embodiment of the present disclosure.

Referring to FIG. 1, an all-solid-state battery 10 according to an embodiment may include a positive electrode layer 100, a negative electrode layer 200 opposite to the positive electrode layer 100, and a solid electrolyte layer 300 disposed between the positive electrode layer 100 and the negative electrode layer 200. However, the present disclosure is not limited to the depicted configuration. For example, the all-solid-state battery 10 may further include an additional functional layer, such as an adhesion enhancement layer, disposed between the positive electrode layer 100 and the solid electrolyte layer 300 or between the negative electrode layer 200 and the solid electrolyte layer 300.

The positive electrode layer 100 according to an embodiment may include a positive electrode current collector 110 and a positive electrode active material layer 120 disposed on the positive electrode current collector 110. The positive electrode active material layer 120 may include a positive electrode active material, a solid electrolyte, a conductive material, and a binder.

The positive electrode current collector 110 may provide a reference surface to which the positive electrode active material layer 120 is disposed. The positive electrode current collector 110 may include a plate or a foil including, for example, indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof.

Unlike the embodiment shown in FIG. 1, in another embodiment of the present disclosure, the positive electrode current collector 110 may be omitted. Although not shown, in order to increase an adhesion between the positive electrode current collector 110 and the positive electrode active material layer 120, in another embodiment a carbon layer having a thickness of about 0.1 μm to about 4 μm may be disposed between the positive electrode current collector 110 and the positive electrode active material layer 120.

The positive electrode active material may include a material that can reversibly absorb and desorb lithium ions. The positive electrode active material may include, for example, lithium transition metal oxide (e.g., lithium cobalt oxide (LCO), lithium nickel oxide, lithium nickel cobalt oxide, lithium nickel cobalt aluminum oxide (NCA), lithium nickel cobalt manganese oxide (NCM), lithium manganate, or lithium iron phosphate), nickel sulfide, copper sulfide, lithium sulfide, iron oxide, or vanadium oxide. But the present disclosure is not limited to these examples. The positive electrode active material may be used alone or in a mixture of two or more substances.

The lithium transition metal oxide may be, for example, a compound represented by LiₐA_{1-b}B_{b}D₂ (where 0.90≤a≤1 and 0≤b≤0.5), LiₐE_{1-b}B_{b}O_{2-c}D_{c} (where 0.90≤a≤1, 0≤b≤0.5, and 0≤c≤0.05), LiE_{2-b}B_{b}O_{4-c}D_{c} (where 0≤b≤0.5 and 0≤c≤0.05), LiₐNi_{1-b-c}CO_{b}B_{c}D_{α} (where 0.90≤a≤1, 0≤b≤0.5, 0≤c≤0.05, and 0<α<2), LiₐNi_{1-b-c}CO_{b}B_{c}CO_{2-α}F_{α} (where 0.90≤a≤1, 0≤b≤0.5, 0≤c≤0.05, and 0<α<2), LiₐNi_{1-b-c}Mn_{b}B_{c}D_{α} (where 0.90≤a≤1, 0≤b≤0.5, 0≤c≤0.05, and 0<α≤2), LiₐNi_{1-b-c}Mn_{b}B_{c}O_{2-α}F_{α} (where 0.90≤a≤1, 0≤b≤0.5, 0≤c≤0.05, and 0<α<2), LiₐNi_{b}E_{c}G_{d}O₂ (where 0.90≤a≤1, 0≤b≤0.9, 0≤c≤0.5, and 0.001≤d≤0.1), LiₐNi_{b}Co_{c}Mn_{d}GₑO₂ (where 0.90≤a≤1, 0≤b≤0.9, 0≤c≤0.5, 0≤d≤0.5, and 0.001<α<0.1), LiₐNiG_{b}O₂ (where 0.9≤a≤1 and 0.001≤b≤0.1), LiₐCoG_{b}O₂ (where 0.90≤a≤1 and 0.001≤b≤0.1), LiₐMnG_{b}O₂ (where 0.90≤a≤1 and 0.001≤b≤0.1), LiₐMn₂G_{b}O₄ (where 0.90≤a≤1 and 0.001≤b≤0.1), QO₂, QS₂, LiQS₂, V₂O₅, LiV₂O₅, LiIO₂, LiNiVO₄, Li_{3-f}J₂ (PO₄)₃ (where 0≤f≤2), Li_{3-f}Fe₂(PO₄)₃ (where 0≤f≤2), or LiFePO₄. In the compounds above, “A” may be Ni, Co, Mn, or a combination thereof, “B” may be Al, Ni, Co, Mn, Cr, Fe, Mg, Sr, V, a rare-earth element, or a combination thereof, “D” may be O, F, S, P, or a combination thereof, “E” may be Co, Mn, or a combination thereof, “F” may be F, S, P, or a combination thereof, “G” may be Al, Cr, Mn, Fe, Mg, La, Ce, Sr, V, or a combination thereof, “Q” may be Ti, Mo, Mn, or a combination thereof, “I” may be Cr, V, Fe, Sc, Y, or a combination thereof, and “J” may be V, Cr, Mn, Co, Ni, Cu, or a combination thereof.

The positive electrode active material may include, for example, a lithium salt of transition metal oxide having a layered rock salt type structure among lithium transition metal oxides discussed above. The term “layered rock salt type structure” may refer to a structure in which an oxygen atom layer and a metal atom layer are alternately and regularly arranged in a <111> direction of a cubic rock salt type structure, where each atom layer forms a two-dimensional plane. The term “cubic rock salt type structure” may refer to a sodium chloride (NaCl) type structure, which is a type of crystal structure. Such a structure may have, for example, face centered cubic lattices (FCCs) each formed of cations and anions that are displaced from each other by ½ of a ridge of a unit lattice. The lithium transition metal oxide having the layered rock salt type structure may be a ternary lithium transition metal oxide, such as LiNiₓCo_{y}Al_{z}O₂ (NCA) or LiNiₓCo_{y}Mn_{z}O₂ (NCM) (where 0<x<1, 0<y<1, 0<z<1, and x+y+2=1). When the positive electrode active material includes a ternary lithium transition metal oxide having the layered rock salt type structure, the all-solid-state battery 10 may have increased energy density and improved thermal stability.

The compound included in the positive electrode active material may be covered with a coating layer (not shown). The positive electrode active material may be used in a mixture of the compound and a compound to which the coating layer is added. The coating layer added to a surface of the positive electrode active material may include, for example, oxide, hydroxide, oxyhydroxide, oxycarbonate, or hydrocarbonate of a coating element discussed below. The compound forming the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may include, for example, Li₂O—ZrO₂ (LZO). Any method may be used to form the coating layer so long as the method does not adversely affect physical characteristics of the positive electrode active material. For example, spray coating or immersion may be used to form the coating layer.

When the positive electrode active material includes nickel (Ni) as a ternary lithium transition metal oxide, such as NCA or NCM, a capacity density of the all-solid-state battery 10 may increase to reduce metal elution of the positive electrode active material in a charged state. Thus, the all-solid-state battery 10 may have improved cycle characteristics in a charged state. Herein, “cycle characteristics” refers to properties that indicate the degree to which the all-solid-state battery 10 is degraded due to charging and discharging. For example, the all-solid-state battery 10 with high cycle characteristics degrades less due to charging and discharging, while the all-solid-state battery 10 with low cycle characteristics degrades more due to charging and discharging.

The positive electrode active material may have, for example, a spherical or oval particulate shape. According to the present disclosure, there is no limitation on a particle diameter and an amount of the positive electrode active material.

The solid electrolyte may include a sulfide-based solid electrolyte with excellent lithium ion conductivity. The sulfide-based solid electrolyte may include, for example, one or more of Li₂S—P₂S₅, Li₂S—P₂S₅—LiX (where X is a halogen element), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are each a positive integer, and “Z” is one of Ge, Zn, and Ga), Li₂S—GeS₂, Li₂S—SiS₂—Li₃PO₄, Li₂S—SiS₂-LiₚMO_{q} (where p and q are each a positive integer, and “M” is one of P, Si, Ge, B, Al, Ga, and In), Li₇₋ₓPS₆₋ₓClₓ (where 0≤x≤2), Li₇₋ₓPS₆₋ₓBrₓ (where 0≤x≤2), and Li₇₋ₓPS₆₋ₓIₓ (where 0≤x≤2).

The sulfide-based solid electrolyte may be an argyrodite-type compound including, for example, one or more of Li₇₋ₓPS₆₋ₓClₓ (where 0≤x≤2), Li₇₋ₓPS₆₋ₓBrₓ (where 0≤x≤2), and Li₇₋ₓPS₆₋ₓIₓ (where 0≤x≤2). For example, the sulfide-based solid electrolyte may be an argyrodite-type compound including at least one of Li₆PS₅Cl, Li₆PS₅Br, and Li₆PS₅I.

Alternatively, the sulfide-based solid electrolyte may be an argyrodite-type compound including Li₇₋ₐMₐPS_{6-c}X_{c} (where 0≤a≤2 and 0≤c≤2). In the chemical formula above, X may be F, Br, Cl, or a combination thereof. M may be scandium (Sc), yttrium (Y), titanium (Ti), zirconium (Zr), hafnium (Hf), vanadium (V), niobium (Nb), tantalum (Ta), chromium (Cr), molybdenum (Mo), tungsten (W), manganese (Mn), technetium (Tc), rhenium (Re), iron (Fe), ruthenium (Ru), osmium (Os), cobalt (Co), rhodium (Rh), iridium (Ir), nickel (Ni), palladium (Pd), platinum (Pt), copper (Cu), silver (Ag), gold (Au), zinc (Zn), cadmium (Cd), mercury (Hg), aluminum (Al), gallium (Ga), indium (In), thallium (TI), silicon (Si), germanium (Ge), tin (Sn), lead (Pb), arsenic (As), antimony (Sb), bismuth (Bi), or a combination thereof.

The argyrodite-type solid electrolyte may have a density of about 1.5 g/cc to about 2.0 g/cc. As the argyrodite-type solid electrolyte has a density of equal to or greater than about 1.5 g/cc, it may be possible to decrease an internal resistance of an all-solid-state battery, prevent the solid electrolyte layer from short-circuiting, and prevent the formation of lithium dendrites. The solid electrolyte may have an elastic modulus of, for example, about 15 GPa to about 35 GPa.

The solid electrolyte included in the positive electrode active material layer 120 may have a medium-sized average particle diameter (D50) that is less than the average particle diameter (D50) of a solid electrolyte included in the solid electrolyte layer 300. For example, the medium-sized average particle diameter (D50) of the solid electrolyte in the positive electrode active material layer 120 may be about equal to or less than about 90%, 80%, 70%, 60%, 50%, 40%, 30%, or 20% of the medium-sized average particle diameter (D50) of a solid electrolyte included in the solid electrolyte layer 300. The medium-sized average particle diameter (D50) may be a median diameter measured by a laser particle size distribution analyzer.

The positive electrode active material layer 120 may include a conductive material. The conductive material may provide conductivity without causing chemical change in the all-solid-state battery 10 to thereby increase conductivity of the positive electrode active material and the solid electrolyte. The conductive material may include a carbon-based material. The conductive material may include, for example, one or more of graphite, carbon black, acetylene black, carbon nano-fiber, and carbon nano-tube.

The positive electrode active material layer 120 may further include a binder. The binder may include a material that adheres the positive electrode active material, the solid electrolyte, and the conductive material included in the positive electrode active material layer 120 to each other. The binder may also improves adhesion between the positive electrode active material layer 120 and the positive electrode current collector 110. The binder may include, for example, one or more of polyvinylidenefluoride, styrene-butadiene rubber (SBR), polytetrafluoroethylene, vinylidenefluoride/hexafluoropropylene copolymers, polyacrylonitrile, and polymethyl methacrylate.

Based on 100 parts by weight of the positive electrode active material, the solid electrolyte, the conductive material, and the binder, the positive electrode active material may be included in an amount of about 85 parts by weight to about 92 parts by weight in the positive electrode active material layer 120. Based on 100 parts by weight of the positive electrode active material, the solid electrolyte, the conductive material, and the binder, the positive electrode active material may be included in an amount of about 0.5 parts by weight to about 1.5 parts by weight in the positive electrode active material layer 120.

Based on 100 parts by weight of the solid electrolyte, the conductive material may be included in an amount of the about 1 part by weight to about 50 parts by weight in the positive electrode active material layer 120. When the amount of the conductive material in the positive electrode active material layer 120 is less than about 1 part by weight based on 100 parts by weight of the solid electrolyte, a proportion of the conductive material may decrease to reduce electrical conductivity of the positive electrode active material layer 120. When the amount of the conductive material in the positive electrode active material layer 120 is greater than about 50 parts by weight based on 100 parts by weight of the solid electrolyte, a proportion of the conductive material may excessively increase to cause incomplete formation of a coating layer that covers a surface of the solid electrolyte.

The positive electrode active material layer 120 may further include an additive, such as a filler, a coating agent, a dispersant, and an ion conductivity agent, in addition to the positive electrode active material, the solid electrolyte, the conductive material, and the binder.

The solid electrolyte layer 300 may be disposed between the positive electrode layer 100 and the negative electrode layer 200. The solid electrolyte layer 300 may include a sulfide-based solid electrolyte with excellent lithium ion conductivity. The solid electrolyte included in the solid electrolyte layer 300 may be the same as or different from the solid electrolyte included in the positive electrode active material layer 120.

In an embodiment, the solid electrolyte layer 300 may include a sulfide-based solid electrolyte. The sulfide-based solid electrolyte may be prepared, for example, by melt extraction or mechanically milling a starting raw material such as Li₂S or P₂S₅, the resultant of which may be thermally treated. The solid electrolyte may be in an amorphous state, a crystalline state, or a mixed state of amorphous and crystalline states. The solid electrolyte may include at least sulfur(S), phosphorus (P), and lithium (Li) among component elements included in the sulfide-based solid electrolyte mentioned above. For example, the solid electrolyte may be a material including Li₂S—P₂S₅. When a material including Li₂S—P₂S₅ is used as the sulfide-based solid electrolyte material of the solid electrolyte, a mixing molar ratio of Li₂S and P₂S₅ may be in a range of about 50:50 to about 90:10.

The sulfide-based solid electrolyte may be an argyrodite-type compound including, for example, at least one of Li₇₋ₓPS₆₋ₓClₓ (where 0≤x≤2), Li₇₋ₓPS₆₋ₓBrₓ (where 0≤x≤2), and Li₇₋ₓPS₆₋ₓIₓ (where 0≤x≤2). For example, the sulfide-based solid electrolyte may be an argyrodite-type compound including at least one of Li₆PS₅Cl, Li₆PS₅Br, and Li₆PS₅I.

Alternatively, the sulfide-based solid electrolyte may be an argyrodite-type compound including Li₇₋ₐMₐPS_{6-c}X_{c} (where 0≤a≤2 and 0≤c≤2). In this chemical formula, X may be F, Br, Cl, or a combination thereof, and M may be scandium (Sc), yttrium (Y), titanium (Ti), zirconium (Zr), hafnium (Hf), vanadium (V), niobium (Nb), tantalum (Ta), chromium (Cr), molybdenum (Mo), tungsten (W), manganese (Mn), technetium (Tc), rhenium (Re), iron (Fe), ruthenium (Ru), osmium (Os), cobalt (Co), rhodium (Rh), iridium (Ir), nickel (Ni), palladium (Pd), platinum (Pt), copper (Cu), silver (Ag), gold (Au), zinc (Zn), cadmium (Cd), mercury (Hg), aluminum (Al), gallium (Ga), indium (In), thallium (TI), silicon (Si), germanium (Ge), tin (Sn), lead (Pb), arsenic (As), antimony (Sb), bismuth (Bi), or a combination thereof.

The argyrodite-type solid electrolyte may have a density of about 1.5 g/cc to about 2.0 g/cc. As the argyrodite-type solid electrolyte has a density of equal to or greater than about 1.5 g/cc, it may be possible to decrease an internal resistance of an all-solid-state battery, prevent the solid electrolyte layer from short-circuiting, and prevent the formation of lithium dendrites. The solid electrolyte may have an elastic modulus of, for example, about 15 GPa to about 35 GPa.

The solid electrolyte layer 300 may further include a binder. The binder included in the solid electrolyte layer 300 may include styrene-butadiene rubber (SBR), polytetrafluoroethylene, polyvinylidenefluoride, polyethylene, but the present disclosure is not limited to these examples. The binder of the solid electrolyte layer 300 may be the same as or different from the binder of the positive electrode active material layer 120 or the binder of a coating layer 220 (which will be discussed below).

Although not shown, a carbon layer may be included to increase an adhesive force between the coating layer 220 and the solid electrolyte layer 300.

Referring again to FIG. 1, in the all-solid-state battery 10, the negative electrode layer 200 may include a negative electrode current collector 210 and a coating layer 220 disposed on the negative electrode current collector 210.

Referring to FIG. 2, the all-solid-state battery 10 according to an embodiment may further include a lithium metal layer 230, which may be formed when the battery charged, between the negative electrode current collector 210 and the coating layer 220.

The lithium metal layer 230 may include lithium or lithium alloy. As the lithium metal layer 230 includes lithium, the lithium metal layer 230 may function as a lithium reservoir. The lithium alloy may be, for example, Li—Al alloy, Li—Sₙ alloy, Li—In alloy, Li—Ag alloy, Li—Au alloy, Li—Zn alloy, Li—Ge alloy, or Li—Si alloy, but other suitable lithium alloys may be used. The lithium metal layer 230 may be formed of lithium, an alloy, or several types of alloys. The lithium metal layer 230 may be a plated layer. For example, the lithium metal layer 230 may be plated (or precipitated) between the coating layer 220 and the negative electrode current collector 210 during charging of the all-solid-state battery 10.

A thickness of the lithium metal layer 230 may be, but is not limited to, about 1 μm to about 500 μm, about 1 μm to about 200 μm, about 1 μm to about 150 μm, about 1 μm to about 100 μm, or about 1 μm to about 50 μm. When the lithium metal layer 230 is too thin, it may be hard for the lithium metal layer 230 to function as a lithium reservoir. When the lithium metal layer 230 has is too thick, the all-solid-state battery 10 has increased mass and volume and decreased cycle characteristics.

In an embodiment, the lithium metal layer 230 in the negative electrode layer 200 may be provided between the negative electrode current collector 210 and the coating layer 220. For example, the lithium metal layer 230 may be provided before the all-solid-state battery 10 is fully assembled. When the lithium metal layer 230 is disposed between the negative electrode current collector 210 and the coating layer 220 before the all-solid-state battery 10 is assembled, the lithium metal layer 230 function as a lithium reservoir. In an example embodiment, before the all-solid-state battery 10 is assembled, a lithium foil may be placed between the negative electrode current collector 210 and the coating layer 220.

When the lithium metal layer 230 is formed by precipitation resulting from charging after the all-solid-state battery 10 is assembled, the lithium metal layer 230 is not provided when the all-solid-state battery 10 is assembled. Thus, the all-solid-state battery 10 may have an increased energy density. When the all-solid-state battery 10 is charged, the charging may be carried out beyond a charging capacity of the coating layer 220. That is, the coating layer 220 may be over-charged. At an initial charging stage, the coating layer 220 may absorbe lithium. When the coating layer 220 is charged beyond the capacity thereof, for example, lithium may precipitate between the coating layer 220 and the negative electrode current collector 210. And the precipitated lithium may form the lithium metal layer 230.

The lithium metal layer 230 may be mainly formed of lithium (e.g., metal lithium). During discharging, lithium of the lithium metal layer 230 may be ionized to migrate toward the positive electrode layer 100. Thus, in example embodiments, lithium may be used as a negative electrode active material in the all-solid-state battery 10. In addition, since the coating layer 220 coats the lithium metal layer 230, the coating layer 220 may protect the lithium metal layer 230 and also suppress precipitation and growth of lithium dendrites. Thus, the coating layer 220 may prevent short-circuiting, prevent capacity reduction, and improve cycle characteristics of the all-solid-state battery 10.

When the lithium metal layer 230 is formed by charging after the all-solid-state battery 10 is assembled, the negative electrode layer 200, the negative electrode current collector 210, the coating layer 220, and an area therebetween, may be a Li-free region that does not include lithium (Li) in an initial state or fully discharged state of the all-solid-state battery 10.

Referring again to FIGS. 1 and 2, the negative electrode layer 200 may include the negative electrode current collector 210 and the coating layer 220 disposed on the negative electrode current collector 210. The coating layer 220 may be formed by coating a negative electrode slurry on the negative electrode current collector 210.

The negative electrode slurry, coating layer, and negative electrode will now be described.

### Negative Electrode Slurry

A coating layer may be formed by coating a negative electrode slurry on a negative electrode current collector.

The negative electrode slurry may include a solvent, a binder, and a metal-carbon composite in which a metal and a carbon-based material are chemically bonded by sulfur.

An average particle diameter (D50) of the metal-carbon composite present in the negative electrode slurry may be, for example, about 150 nm to about 1,000 nm, about 160 nm to about 900 nm, about 170 nm to about 700 nm, about 180 nm to about 650 nm, about 190 nm to about 600 nm, or about 200 nm to about 550 nm.

The average particle diameter of the metal-carbon composite may be, for example, a value measured by using dynamic light scattering (DLS) after dilution of the negative electrode slurry. Besides DLS, other suitable methods for measuring an average particle diameter may be used.

When the dynamic light scattering is used, the negative electrode slurry may be diluted, for example, approximately 100,000 times. As those skilled in the art will recognize, the dilution may be performed before the DLS measurement to prevent multiple scattering and to increase measurement accuracy. There is no limitation on a dilution ratio as long as it is appropriate for DLS measurement.

When the average particle diameter (D50) of the metal-carbon composite in the negative electrode slurry is greater than the ranges described above, agglomeration between particles may occur during coating, and, thus, unevenness may occur on one side of the coating layer. The occurrence of unevenness in the coating layer may result in a protrusion with a large diameter being generated on one side of the coating layer and/or a plurality of protrusions being formed. In other words, a coating layer with irregular thickness may be formed, and the coating layer may prevent lithium from being uniformly electrodeposited on the negative electrode current collector when a lithium metal layer is formed due to charging and discharging of the secondary battery. A “large diameter” of the protrusion may indicate that, for example, that the diameter of the protrusion is equal to or greater than 50 μm, 60 μm, 70 μm, 80 μm, 90 μm, or 100 μm.

When the average particle diameter (D50) of the metal-carbon composite in the negative electrode slurry is less than the ranges described above, a specific surface area of the metal-carbon composite may increase to thereby lead to an increased amount of the binder used during dispersion. When the binder is present in an excessive amount, the negative electrode slurry may have high viscosity. An increase in viscosity of the negative electrode slurry may make it difficult to achieve a uniform coating thickness when the coating layer is formed. When the thickness of the coating layer is not uniform, lithium may not be uniformly electrodeposited, which may result in deteriorated cell characteristics of the all-solid-state battery. In addition, when the binder is present in an excessive amount, electrical resistance may increase. Thus, in sum, when the binder is present in an excessive amount in the coating layer, a negative electrode may have reduced coating film conductivity and increased resistance such that an all-solid-state battery has deteriorated cell characteristics.

When the average particle diameter (D50) of the metal-carbon composite in the negative electrode slurry is within the ranges described above, the coating layer formed from the negative electrode slurry may have a uniform thickness and significantly reduced unevenness on one side thereof. For example, protrusion(s) formed in the coating layer may be small in number and diameter. A “small diameter” of a protrusion may indicate that, for example, the diameter of the protrusion is equal to or less than 40 μm, 35 μm, 30 μm, 25 μm, or 20 μm. Additionally, in an all-solid-state battery including the coating layer, lithium may be uniformly electrodeposited between the negative electrode current collector and the coating layer, and the all-solid-state battery may have excellent cell characteristics such as charging/discharging efficiency.

The negative electrode slurry may have viscosity, for example, of about 200 cps to about 1,000 cps, about 200 cps to about 900 cps, about 250 cps to about 900 cps, about 300 cps to about 800 cps, about 350 cps to about 800 cps, about 400 cps to about 800 cps, about 400 cps to about 700 cps, or about 400 cps to about 650 cps. When the viscosity of the negative electrode slurry is outside such ranges, the coating layer may be formed with an irregular thickness.

The negative electrode slurry may include a solvent, a binder, and a metal-carbon composite in which a metal and a carbon-based material are chemically bonded by sulfur. The negative electrode slurry may further include a second binder. The negative electrode slurry may further include a filler, a coating agent, a dispersant, an ion conductivity agent, or a combination thereof.

The binder may be an aqueous binder. The binder may include an acrylate-based binder, a polyvinylpyrrolidone-based binder, a polyvinylalcohol-based binder, a cellulose-based binder, or a combination thereof. The binder may be, for example, a cellulose-based binder. The binder may include carboxymethyl cellulose (CMC), methyl cellulose (MC), hydroxypropyl cellulose (HPC), methyl hydroxypropyl cellulose (MHPC), ethyl hydroxyethyl cellulose (EHEC), methyl ethyl hydroxyethyl cellulose (MEHEC), cellulose gum, or a combination thereof.

The solvent may be an aqueous solvent. The aqueous solvent may be a solvent including water as a primary component. The solvent may be, for example, deionized water (DIW).

The binder may be present in an amount of about 0.2 wt % to about 0.75 wt %, about 0.2 wt % to about 0.74 wt %, about 0.22 wt % to about 0.74 wt %, or about 0.25 wt % to about 0.72 wt % relative to the total weight of the negative electrode slurry.

The negative electrode slurry may include a metal-carbon composite in which a metal and a carbon-based material are chemically bonded by sulfur. The metal-carbon composite may include, for example, a covalent bond between the carbon-based material and the sulfur and a covalent bond between the sulfur and the metal.

A chemical bond via sulfur(S) may be obtained by using a raw sulfur material in a fabrication process of the metal-carbon composite. The raw sulfur material may include, for example, a thiol compound, a sulfide-based compound, a thiophene-based compound, sulfonic acid, sulfone, sulfoxide, or a combination thereof. The raw sulfur material may be, for example, a thiol compound. The thiol compound may be, for example, mercapto acetic acid, 1-dodecanethiol, 6-mercapto-1-hexanol, 11-mercapto-1-undecanol, 2-naphthalenethiol, 1,4-benzenedimethanethiol, 4-mercaptobenzoic acid, 1,3-benzenedithiol, or a combination thereof.

The chemical bond by sulfur(S) may be confirmed in a spectrum obtained from x-ray photoelectron spectroscopy (XPS) analysis on the metal-carbon composite. For example, when the metal is silver (Ag), the S2p spectrum obtained from XPS analysis may exhibit a peak in a bond energy range of 160 eV to 162 eV. The peak may correspond to an Ag—S bond.

FIG. 8 is a diagram showing a metal-carbon composite bonded by sulfur according to an embodiment of the present disclosure.

Referring to FIG. 8, the metal-carbon composite according to the present disclosure may include a carbon-based material CBM and a metal MTP. In an embodiment of the present disclosure, the metal-carbon composite may be formed from carbon black and silver (Ag).

The metal MTP may have a particulate shape. The metal MTP may include a metal nano-particle. The metal MTP may include gold (Au), platinum (Pt), palladium (Pd), silicon (Si), silver (Ag), aluminum (Al), magnesium (Mg), germanium (Ge), copper (Cu), indium (In), nickel (Ni), bismuth (Bi), tin (Sn), zinc (Zn), or a combination thereof. The metal MTP may improve electrical conductivity of the negative electrode layer 200. In a specific example, the metal MTP may form an alloy with lithium, and may form a lithium deposition layer on a lower portion of the coating layer 220.

The carbon-based material CBM may be amorphous carbon, crystalline carbon, or a mixture thereof.

The amorphous carbon may include, for example, carbon black, acetylene black, Denka black, furnace black, ketjen black, activated carbon, or a combination thereof. The carbon black may include, for example, SUPER P™, which is commercially available from Timcal Ltd.

The amorphous carbon may be in the form of single particles or secondary particles in which primary particles are combined. When the amorphous carbon is single particles, the particles may have an average particle diameter of equal to or less than about 100 nm, for example, a nano-size of about 10 nm to about 100 nm.

When the amorphous carbon is in the form of secondary particles, the primary particles may have a particle diameter of about 20 nm to about 100 nm, and the secondary particles may have a particle diameter of about 1 μm to about 20 μm. For example, the particle diameters of the primary particles may be equal to or greater than about 20 nm, 30 nm, 40 nm, 50 nm, 60 nm, 70 nm, 80 nm, or 90 nm, or may be equal to or less than about 100 nm, 90 nm, 80 nm, 70 nm, 60 nm, 50 nm, 40 nm, or 30 nm. The particle diameter sof the secondary particles may be equal to or greater than 1 μm, 3 μm, 5 μm, 7 μm, 10 μm, or 15 μm, or may be equal to or less than about 20 μm, 15 μm, 10 μm, 7 μm, 5 μm, or 3 μm. The primary particles may have a spherical shape, an oval shape, a plate shape, or a combination thereof.

The crystalline carbon may include, for example, natural graphite, artificial graphite, carbon nano-tube, graphene, or a combination thereof. The crystalline carbon may have an amorphous shape, a plate shape, a flake shape, a spherical shape, or a fibrous shape.

Referring again to FIG. 8, a carbon atom C of the carbon-based material CBM may be chemically bonded by sulfur to a silver atom Ag of the metal MTP. A first covalent bond CVB1 may be formed between a sulfur atom S and the carbon atom C of the carbon-based material CBM. A second covalent bond CVB2 may be formed between the sulfur atom S and the silver atom Ag of the metal MTP. The first covalent bond CVB1 and the second covalent bond CVB2 may thereby chemically bond the carbon-based material CBM and the metal MTP to each other.

As the carbon-based material and the metal of the metal-carbon composite are chemically bonded by sulfur(S), a bonding force may be superior to a physical bond, and the metal and the carbon-based material may not separate from each other when the coating layer is formed. In addition, the metal may be uniformly dispersed in the metal-carbon composite by sulfur(S) that is uniformly distributed in the carbon-based material. As the metal is uniformly dispersed in the metal-carbon composite, uniform lithium electrodeposition may be achieved in a lithium metal layer formed by charging and discharging of an all-solid-state battery.

The metal-carbon composite may be present in an amount of, for example, about 10 wt % to about 35 wt %, about 10 wt % to about 30 wt %, about 15 wt % to about 30 wt %, about 17 wt % to about 27 wt %, or about 20 wt % to about 25 wt % relative to the total weight of the negative electrode slurry.

### Negative Electrode Layer 200

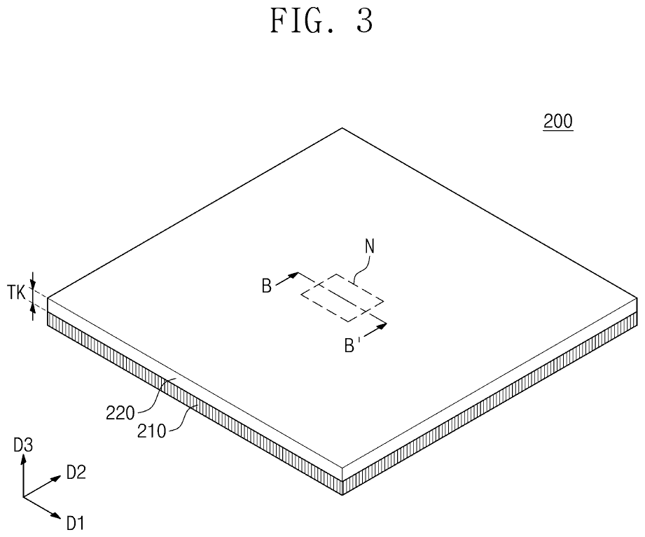

FIG. 3 is a perspective view showing a negative electrode layer according to an embodiment of the present disclosure. Referring to FIG. 3, the negative electrode layer 200 may include the negative electrode current collector 210 and the coating layer 220 disposed on the negative electrode current collector 210.

That is, negative electrode according to an embodiment of the present disclosure may include the negative electrode current collector 210 and the coating layer 220. The coating layer 220 may include a metal-carbon composite in which a metal and a carbon-based material are chemically bonded by sulfur. The metal-carbon composite may have an average particle diameter (D50) of about 150 nm to about 1,000 nm. The average particle diameter (D50) of the metal-carbon composite in the coating layer 220 may be measured, for example, by a transmission electron microscope image or a scanning electron microscope image, but the present disclosure is not limited in this regard.

The negative electrode current collector 210 may provide a reference surface on which the coating layer 220 is disposed. The negative electrode current collector 210 may include a material that does not react with lithium, for example, a material that does not form an alloy or a compound with lithium. A material included in the negative electrode current collector 210 may include, for example, at least one of copper (Cu), stainless steel, titanium (Ti), iron (Fe), cobalt (Co), and nickel (Ni), but the present disclosure is not limited thereto and any material suitable for electrode current collectors may be used. The negative electrode current collector 210 may have a thickness of about 1 to 20 μm, for example, about 5 to 15 μm or about 7 to 10 μm. The negative electrode current collector 210 may be formed of one of the metals mentioned above, an alloy of two or more of the metals mentioned above, or a coating material. The negative electrode current collector 210 may have, for example, a plate or foil shape. In other embodiments, the negative electrode current collector 210 may be omitted.

The coating layer 220 may include a metal, a carbon-based material, and a binder. The coating layer 220 may be formed by coating the negative electrode slurry on the negative electrode current collector 210.

The coating layer 220 may include protrusions on one side thereof. The protrusions may have diameters of, for example, about 40 μm, 35 μm, 30 μm, 25 μm, or 20 μm. The diameters of the protrusions may be determined using, for example, a microscope.

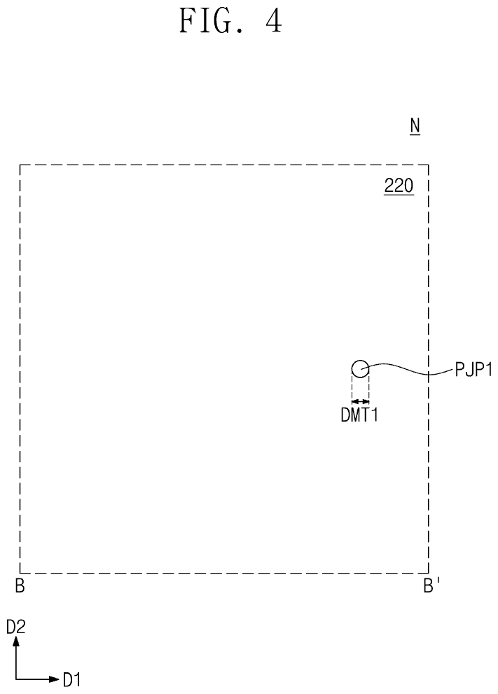

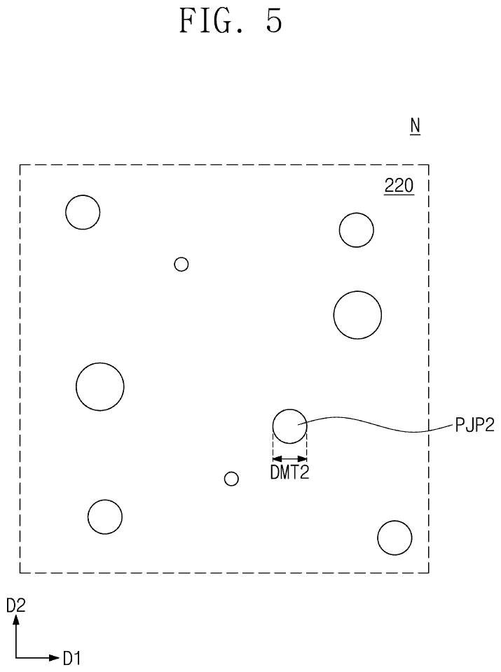

FIG. 4 is a plan view showing section N of the coating layer depicted in FIG. 3. FIG. 5 is a plan view showing section N of a coating layer according to a comparative example of the present disclosure.

Referring to FIG. 4, in the case of the coating layer 220 formed by coating the negative electrode slurry on the negative electrode current collector 210, a first protrusion PJP1 may be formed on one side of the coating layer 220. A diameter DMT1 of the first protrusion PJP1 may be equal to or less than about 40 μm, 35 μm, 30 μm, 25 μm, or 20 μm. The total number of protrusion like the first protrusion PJP1 formed on one side of the coating layer 220 may be small and the diameters of the protrusions may be small. Thus, the coating layer 220 may be even and uniform in thickness.

FIG. 5 depicts one side of the coating layer 220 in a case where the average particle diameter (D50) of the metal-carbon composite on the negative electrode slurry is deviated from the ranges described above. In the comparative example shown in FIG. 5, a second protrusion PJP2 may be formed on one side of the coating layer 220. A diameter DMT2 of the second protrusion PJP2 may be equal to or greater than about 50 μm, 60 μm, 70 μm, 80 μm, 90 μm, or 100 μm. Compared to the protrusions like the first protrusion PJP1 shown in FIG. 4, the protrusions like the second protrusion PJP2 formed on one side of the coating layer 220 in FIG. 5 may be large in number and diameter. Thus, the coating layer 220 may be uneven and irregular in thickness.

As discussed above, the coating layer 220 on the negative electrode current collector 210 may have a regular thickness, and the binder may not be provided in an excessive amount, which may result in excellent electrical conductivity. The coating layer 220 may have a coating resistance of, for example, about 5 mΩ to about 40 mΩ, about 5 mΩ to about 35 mΩ, about 5 mΩ to about 30 mΩ, about 10 mΩ to about 30 mΩ, about 10 mΩ to about 25 mΩ, or about 10 mΩ to about 20 mΩ. When the coating resistance of the coating layer 220 is deviates from such ranges, an all-solid-state battery may have poor efficiency of charging and discharging.

The coating layer 220 may induce growth of lithium metal between the coating layer 220 and the negative electrode current collector 210 when the all-solid-state battery 10 is charged. Alternatively, the coating layer 220 may cause growth of lithium metal or alloy formation with lithium therein when the all-solid-state battery 10 is charged. The coating layer 220 may serve as a protection layer for lithium metal and simultaneously may suppress precipitation and growth of lithium dendrites.

The coating layer 220 may have a thickness TK of, for example, about 5 μm to about 15 μm, about 6 μm to about 14 μm, about 7 μm to about 13 μm, or about 8 μm to about 12 μm. When the coating layer 220 is too thin, lithium dendrites formed between the coating layer 220 and the negative electrode current collector 210 may collapse the coating layer 220, thereby reducing cycle characteristics of the all-solid-state battery 10. When the coating layer 220 is too thick, the all-solid-state battery 10 may have a decreased energy density and an increased internal resistance caused by the coating layer 220, thereby reducing cycle characteristics of the all-solid-state battery 10. Although not shown, a carbon layer may be included to increase an adhesive force between the coating layer 220 and the solid electrolyte layer 300.

The coating layer 220 may be a metal-carbon composite in which a metal and a carbon-based material are chemically bonded by sulfur.

The metal may be in the form of nano-particles. A crystal size of the metal may be, for example, about 40 nm to about 70 nm, about 45 nm to about 65 nm, or about 50 nm to about 60 nm. The crystal size of the metal may be analyzed by using X-ray diffraction (XRD). When the particle diameter and the crystal size of the metal fall within the ranges described above, the coating layer 220 may have a uniform current density and the all-solid-state battery 10 may have an increased lifespan.

The metal in the coating layer 220 may be about 12 wt % to about 30 wt %, about 12 wt % to about 25 wt %, about 12 wt % to about 20 wt %, or about 12 wt % to about 18 wt % relative to the total weight of the metal-carbon composite. When the amount of the metal is within such ranges, lithium ions released from a positive electrode active material may migrate toward the negative electrode layer 200 when the all-solid-state battery 10 is charged, and a lithium deposition layer may be substantially formed between the negative electrode current collector 210 and the coating layer 220.

The coating layer 220 may further include an additive in addition to the metal, the carbon-based material, and the binder. In particular, the coating layer 220 may include an additive such as a filler, a coating agent, a dispersant, an ion conductivity agent, or a combination thereof.

Hereinafter, the present disclosure will be described in detail with reference to particular embodiments. The following embodiments are provided for illustrative purpose only do not limit the scope of the present disclosure.

### Embodiment 1

1) A metal-carbon composite was made, with the metal-carbon composite including silver (Ag) and a carbon-based material that were chemically bonded by sulfur(S). Details of the process follow.

Carbon black and 2-aphthalene thiol powder were mixed. The mixture was thermally treated at 70° C. to 110° C. The heat-treated product, AgNO₃, a NaBH₄ reducing agent, and water were mixed to prepare a dipping product. The dipping product was thermally treated at 100° C. to 500° C. under a nitrogen atmosphere to make the metal-carbon composite.

2) The metal-carbon composite was mixed in a binder solution to prepare a mixture. In the binder solution, deionized water (DIW) was used as a solvent, and carboxymethyl cellulose (CMC) was used as a binder.

3) The mixture was added to Beads Mill. A dispersion process was executed for 20 minutes to prepare a negative electrode slurry.

The metal-carbon composite was present in an amount of 22 wt % relative to the total weight of the negative electrode slurry, and the binder was present in an amount of 0.65 wt % relative to the total weight of the negative electrode slurry.

The metal-carbon composite in the negative electrode slurry was diluted 100,000 times, and dynamic light scattering (DLS) was used to measure an average particle diameter (D50) of the metal-carbon composite. The measured average particle diameter (D50) was 212 nm.

### Embodiment 2

A metal-carbon composite was made by the same method as in Embodiment 1, except that, as measured by the same method, the metal-carbon composite in the negative electrode slurry had an average particle diameter (D50) of 462 nm and the binder was present in an amount of 0.52 wt % relative to the total weight of the negative electrode slurry.

### Embodiment 3

A metal-carbon composite was made by the same method as in Embodiment 1, except that the metal-carbon composite in the negative electrode slurry had an average particle diameter (D50) of 531 nm when measured by the same method and the binder was present in an amount of 0.45 wt % relative to the total weight of the negative electrode slurry.

### Embodiment 4

A metal-carbon composite was made by the same method as in Embodiment 1, except that, when measured by the same method, the metal-carbon composite in the negative electrode slurry had an average particle diameter (D50) of 150 nm and the binder was present in an amount of 0.72 wt % relative to the total weight of the negative electrode slurry.

### Embodiment 5

A metal-carbon composite was made by the same method as in Embodiment 1, except that, when measured by the same method, the metal-carbon composite in the negative electrode slurry had an average particle diameter (D50) of 750 nm and the binder was present in an amount of 0.31 wt % relative to the total weight of the negative electrode slurry.

### Embodiment 6

A metal-carbon composite was made by the same method as in Embodiment 1, except that, when measured by the same method, the metal-carbon composite in the negative electrode slurry had an average particle diameter (D50) of 820 nm and the binder was present in an amount of 0.25 wt % relative to the total weight of the negative electrode slurry.

### Comparative 1

A metal-carbon composite was made by the same method as in Embodiment 1, except that, when measured by the same method, the metal-carbon composite in the negative electrode slurry had an average particle diameter (D50) of 140 nm and the binder was present in an amount of 0.75 wt % relative to the total weight of the negative electrode slurry.

### Comparative 2

A metal-carbon composite was made by the same method as in Embodiment 1, except that, when measured by the same method, the metal-carbon composite in the negative electrode slurry had an average particle diameter (D50) of 135 nm and the binder was present in an amount of 0.81 wt % relative to the total weight of the negative electrode slurry.

### Comparative 3

A metal-carbon composite was made by the same method as in Embodiment 1, except that, when measured by the same method, the metal-carbon composite in the negative electrode slurry had an average particle diameter (D50) of 1,200 nm and the binder was present in an amount of 0.15 wt % relative to the total weight of the negative electrode slurry.

### Manufacture of Negative Electrode Layer

The prepared negative electrode slurry was added to a styrene-butadiene rubber (SBR) aqueous dispersion in an amount of 3% by weight of the negative electrode slurry, and then the mixture was coated on a 10 μm thick stainless-steel foil current collector. After the coating process, the mixture was vacuum-dried at 80° C. to form a coating layer on the negative electrode current collector. A thickness of the coating layer was 10 μm.

### Preparation of Solid Electrolyte Layer

An argyrodite-type solid electrolyte Li₆PS₅Cl and an isobutylyl isobutylate binder solution were mixed with each other. The binder solution was added to a butyl acrylate-based polymer or butyl acrylate (50 wt % of solid content). A mixing ratio of the solid electrolyte and the binder was 98.7:1.3.

The mixing process was executed by using Thiky Mixer. 2 mm-zirconia balls were added to the mixture and then the mixture was agitated again with Thinky Mixer to prepare a slurry. The slurry was casted on a polytetrafluoroethylene film and dried at room temperature to prepare a solid electrolyte layer of 100 μm in thickness.

### Manufacture of Positive Electrode Layer

A positive electrode active material (LiNi_{0.9}Mn_{0.05}Co_{0.05}O₂) coated with Li-coated zinc oxide (LZO), an argyrodite-type solid electrolyte (Li₆PS₅Cl), a conductive material (carbon nano-fibers), and a binder (polytetrafluoroethylene) were mixed in a weight ratio of 85:15:3:1.5 to prepare a mixture.

The prepared mixture was coated on a 10 μm thick aluminum foil current collector and then vacuum-dried at 45° C. to make a positive electrode. A thickness of the positive electrode active material layer was 160 μm.

### Fabrication of All-Solid-State Battery

The negative electrode layer, the solid electrolyte layer, and the positive electrode layer were sequentially stacked and then pressed with a pressure of 4 Nm to fabricate an all-solid-state battery.

### Evaluation 1: Comparison of Viscosity of Negative Electrode Slurry

Viscosity was measured to identify physical properties of the negative electrode slurry prepared in Embodiments 1 to 6 and Comparatives 1 to 3. The results are shown in Table 1.

TABLE 1

| | Viscosity (cps) |
|---|---|
| Embodiment 1 | 612 |
| Embodiment 2 | 587 |
| Embodiment 3 | 436 |
| Embodiment 4 | 821 |
| Embodiment 5 | 265 |
| Embodiment 6 | 236 |
| Comparative 1 | 1650 |
| Comparative 2 | 1235 |
| Comparative 3 | 115 |

As shown in Table 1, larger average particle diameters (D50) of the metal-carbon composite in the negative electrode slurry cause a reduction in amount of the binder and viscosity of the negative electrode slurry. On the other hand, smaller average particle diameters (D50) of the metal-carbon composite cause an increase in specific surface area of the metal-carbon composite, amount of the binder, and viscosity of the negative electrode slurry.

### Evaluation 2: Coating Resistance

The negative electrode slurry prepared in Embodiments 1 to 6 and Comparatives 1 to 3 was coated on the negative electrode current collector to make a negative electrode plate. A coating resistance of the negative electrode plate was measured by probing 46 pins in a 4-probe method (XF057 commercially available from HIOKI Corporation). The measurement results are shown in Table 2.

TABLE 2

| | Coating resistance (mΩ) |
|---|---|
| Embodiment 1 | 15 |
| Embodiment 2 | 14 |
| Embodiment 3 | 15 |
| Embodiment 4 | 32 |
| Embodiment 5 | 27 |
| Embodiment 6 | 32 |
| Comparative 1 | 62 |
| Comparative 2 | 49 |
| Comparative 3 | 47 |

As can be understood from the results, when an average particle diameter (D50) of the metal-carbon composite deviated from a certain range, coating resistance increased. When coating resistance increases, a battery's internal resistance may be increased, and, thus, charging/discharging efficiency and lifespan characteristics may become deteriorated.

### Evaluation 3: Analysis on Surface of Coating Layer

It was observed that when an average particle diameter (D50) of the metal-carbon composite was too small as shown in Comparatives 1 and 2, the binder was excessively added to cause an increase in viscosity and resistance as shown in Evaluations 1 and 2.

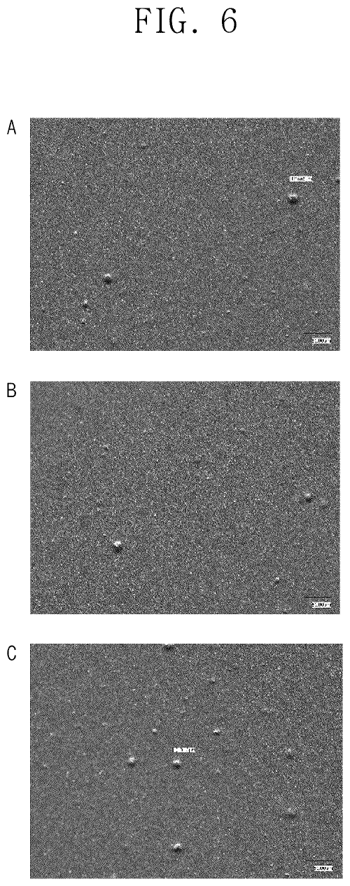

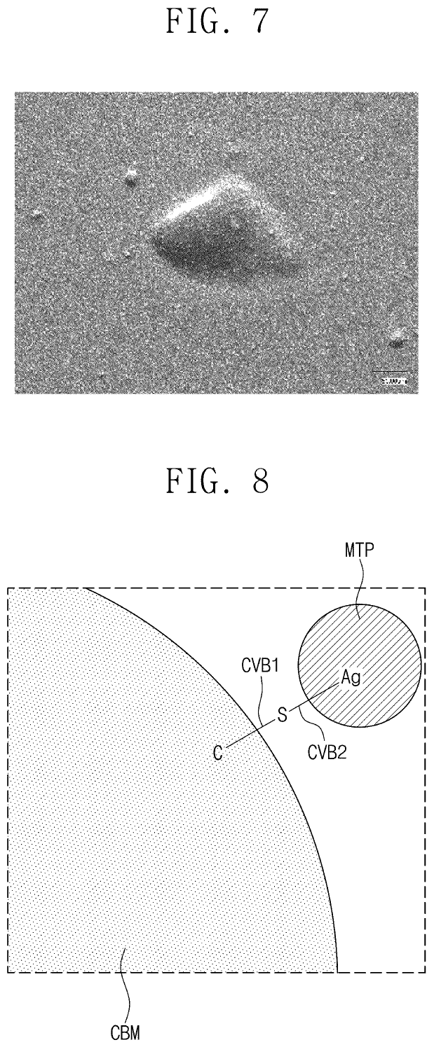

To investigate the reason for the abrupt increase in resistance of Comparative 3 despite the low amount of the binder, a surface of the coating layer made using the negative electrode slurry of Comparative 3 was analyzed. To compare with Comparative 3, surfaces of the coating layers made using the negative electrode slurry of Embodiments 1 to 3 were also analyzed. An optical microscope was used to conduct the surface analysis, and the surfaces of the coating layers were analyzed by measuring a diameters of protrusions in the coating layers at a magnification of 500. The results are shown in FIGS. 6 and 7. FIG. 6 shows surfaces of the coating layers using the negative electrode slurry of Embodiments 1 to 3, and FIG. 7 shows a surface of the coating layer made using the negative electrode slurry of Comparative 3.

It can be seen that, when an average particle diameter (D50) of the metal-carbon composite deviates from a specific range as in in Comparative 3, protrusions are formed having diameters of equal to or greater than 100 μm. However, when an average particle diameter (D50) of the metal-carbon composite was present within the specific ranges as in Embodiments 1 to 3, protrusions are formed with diameters of equal to or less than 20 μm. Thus, when an average particle diameter (D50) of the metal-carbon composite is greater than a specific range, large diameter protrusions are formed, and the coating layer then has an uneven surface with an irregular thickness. When the coating layer has an irregular thickness, lithium may not be uniformly electrodeposited when an all-solid-state battery is charged and discharged.

### Evaluation 4: Lifespan Characteristics

Lifespans of all-solid-state batteries including the coating layers made using the negative electrode slurry according to Embodiments 1 to 6 and Comparatives 1 to 3 were evaluated. The lifespan evaluation was conducted by placing the all-solid-state batteries into a constant-temperature bath at 60° C. The all-solid-state batteries were charged with a constant current of 0.1 C for 10 hours until a battery voltage reached 4.25 V, and then discharged with a constant current of 0.05 C for 20 hours until a battery voltage recharged 2.5 V (first cycle). The all-solid-state batteries were then charged with a constant current of 0.1 C for 10 hours until a battery voltage reached 4.25 V, and then discharged with a constant current of 0.33 C for 3 hours until a battery voltage recharged 2.5 V (second cycle). The all-solid-state batteries were then charged with a constant current of 0.1 C for 10 hours until a battery voltage reached 4.25 V. The all-solid-state batteries were then discharged with a constant current of 0.5° C. for 2 hours until a battery voltage reached 2.5 V (third cycle). The all-solid-state battery were then charged with a constant current of 0.1 C for 10 hours until a battery voltage reached 4.25 V. The all-solid-state battery were then discharged with a constant current of 1 C for 1 hour until a battery voltage reached 2.5 V (fourth cycle). The all-solid-state battery were then charged with a constant current of 0.33 C for 3 hours until a battery voltage reached 4.25 V. The all-solid-state battery were then discharged with a constant current of 0.33 C for 3 hour until a battery voltage reached 2.5V (fifth cycle). The cycles were repeated a total of 50 times to evaluate a capacity retention rate based on the number of cycles.

$$Note , capacity retention rate ( \% ) = ( discharging capacity after each cycle / discharging capacity at {1}^{st} cycle ) \times 100$$

When the capacity retention rate was 98% or higher, lifespan characteristics were evaluated as Good. When the capacity retention rate was less than 98%, lifespan characteristics were evaluated as Bad. The results are shown in Table 3.

TABLE 3

| | Lifespan characteristics |
|---|---|
| Embodiment 1 | Good |
| Embodiment 2 | Good |
| Embodiment 3 | Good |
| Embodiment 4 | Good |
| Embodiment 5 | Good |
| Embodiment 6 | Good |
| Comparative 1 | Bad |
| Comparative 2 | Bad |
| Comparative 3 | Bad |

In summary, when an average particle diameter (D50) of the metal-carbon composite is too small, the coating layer may have a constant thickness, but a coating resistance increase to thereby cause deterioration of lifespan characteristics of the all-solid-state battery. In addition, when an average particle diameter (D50) of the metal-carbon composite is too large, a thickness of the coating layer may be irregular due to unevenness in the coating layer, and, thus, uniform electrodeposition of lithium may be hindered when the all-solid-state battery is charged and discharged, which may result in deterioration in lifespan characteristics.

A negative electrode slurry for an all-solid-state battery according to the present disclosure may form a coating layer having a uniform thickness. In addition, the all-solid-state battery including the coating layer may have excellent charging/discharging efficiency and improved cell characteristics.

What is claimed is:

1. A negative electrode slurry for an all-solid-state battery, the negative electrode slurry comprising:
a metal-carbon composite in which a metal and a carbon-based material are chemically bonded by sulfur;
a binder; and
a solvent,
wherein an average particle diameter (D50) of the metal-carbon composite is about 150 nm to about 1,000 nm.

2. The negative electrode slurry of claim 1, wherein a viscosity of the negative electrode slurry is about 200 cps to about 1,000 cps.

3. The negative electrode slurry of claim 1, wherein the metal-carbon composite comprises:
a covalent bond between the carbon-based material and the sulfur; and
a covalent bond between the sulfur and the metal.

4. The negative electrode slurry of claim 1, wherein the binder is about 0.2 wt % to about 0.75 wt % relative to a total weight of the negative electrode slurry.

5. The negative electrode slurry of claim 1, wherein the binder is an aqueous binder.

6. The negative electrode slurry of claim 1, wherein the binder comprises one or more of an acrylate-based binder, a polyvinylpyrrolidone-based binder, a polyvinylalcohol-based binder, and a cellulose-based binder.

7. The negative electrode slurry of claim 1, wherein the binder is a cellulose-based binder.

8. The negative electrode slurry of claim 1, wherein the binder comprises one or more of carboxymethyl cellulose (CMC), methyl cellulose (MC), hydroxypropyl cellulose (HPC), methyl hydroxypropyl cellulose (MHPC), ethyl hydroxyethyl cellulose (EHEC), methyl ethyl hydroxyethyl cellulose (MEHEC), and cellulose gum.

9. The negative electrode slurry of claim 1, wherein the solvent is an aqueous solvent.

10. The negative electrode slurry of claim 1, wherein the metal-carbon composite is about 10 wt % to about 35 wt % relative to a total weight of the negative electrode slurry.

11. The negative electrode slurry of claim 1, wherein the carbon-based material comprises at least one of carbon black, acetylene black, furnace black, ketjen black, and graphene, and
wherein the metal comprises at least one of gold (Au), platinum (Pt), palladium (Pd), silicon (Si), silver (Ag), aluminum (Al), bismuth (Bi), tin (Sn), and zinc (Zn).

12. A negative electrode for an all-solid-state battery, the negative electrode comprising:
a negative electrode current collector; and
a coating layer,
wherein the coating layer comprises a metal-carbon composite in which a metal and a carbon-based material are chemically bonded by sulfur,
wherein an average particle diameter (D50) of the metal-carbon composite is about 150 nm to about 1,000 nm.

13. The negative electrode of claim 12, wherein a coating resistance of the negative electrode is about 5 mΩ to about 40 mΩ.

14. The negative electrode of claim 12, wherein a diameter of a protrusion on one side of the coating layer is equal to or less than about 40 μm.

15. The negative electrode of claim 12, wherein a thickness of the coating layer is about 5 μm to about 15 μm.

16. The negative electrode of claim 12, wherein the metal in the metal-carbon composite in the coating layer is about 12 wt % to about 30 wt %.

17. The negative electrode of claim 12, wherein a crystal size of the metal is about 40 nm to about 70 nm.

18. An all-solid-state battery, comprising:
a positive electrode;
the negative electrode of claim 12; and
a solid electrolyte between the positive electrode and the negative electrode.

19. The all-solid-state battery of claim 18, wherein an area between the coating layer and the negative electrode current collector of the negative electrode is a Li-free region that does not comprise lithium (Li).

20. The all-solid-state battery of claim 18, wherein the negative electrode further comprises a lithium metal layer between the negative electrode current collector and the coating layer,
wherein the lithium metal layer comprises lithium or lithium alloy.
